(19) United States
(12) Patent Application Publication
(10) Pub. No.: US 2012/0196141 A1
(43) Pub. Date: Aug. 2, 2012

(54) HIGH BARRIER FILM LAMINATE

(76) Inventor: Robert Pocius, Hamilton (CA)

(21) Appl. No.: 13/350,857

(22) Filed: Jan. 16, 2012

Related U.S. Application Data
(60) Provisional application No. 61/437,708, filed on Jan. 31, 2011.

(51) Int. Cl. B32B 27/08

(52) U.S. Cl. 428/515

(57) ABSTRACT

A film of laminate construction for producing on a packaging machine a flexible container for containing food includes the following layers. A layer of natural kraft paper for forming an outside layer of the container followed by a layer of adhesive. A layer of PE also known as polyethylene followed by a layer of tie adhesive for bonding two layers together. A layer of EVOH also known as ethylene vinyl alcohol and another layer of tie adhesive for bonding two layers together. A layer of PE sealant also known as polyethylene sealant for forming an inside layer of the container, wherein the layers preferably containing an organoleptic biodegradable additive to accelerate decomposition of the film laminate.

This application claims priority from previously filed U.S. provisional application 61/437,708 filed Jan. 31, 2011 by Robert Pocius under the title High Barrier Film Laminate.

### FIELD OF THE INVENTION

The present concept relates to laminate packaging materials and in particular relates to a high barrier film laminate that is used in the food industry.

### BACKGROUND OF THE INVENTION

Currently high barrier food packaging materials consist of a paper that is laminated to a foil barrier. This construction is used for example in the packaging of coffee and other food-stuffs.

Unfortunately these packaging materials do not break down very easily in land fill sites and also contain heavy metals and other contaminates which are undesirable.

There is a need for a packaging material having high barrier properties that can be used in the food packaging industry, which is easily biodegradable and does not contaminate the landfills with undesirable heavy metals and/or other toxins.

### SUMMARY OF THE INVENTION

The present structure is a film of laminate construction for producing on a packaging machine a flexible container for containing food includes the following layers. A layer of natural Kraft paper for forming an outside layer of the container followed by a layer of adhesive. A layer of PE also known as polyethylene followed by a layer of tie adhesive for bonding two layers together. A layer of EVOH also known as ethylene vinyl alcohol and another layer of tie adhesive for bonding two layers together. A layer of PE sealant also known as polyethylene sealant for forming an inside layer of the container, wherein the layers preferably containing an organoleptic biodegradable additive to accelerate decomposition of the film laminate.

A film of laminate construction for producing on a packaging machine a flexible container for containing food comprising:
a. a layer of natural kraft for forming an outside layer of the container;
b. a layer of adhesive;
c. a layer of PE;
d. a layer of Tie;
e. a layer of EVOH;
f. a layer of Tie;
g. a layer of PE sealant for forming an inside layer of the container;
wherein at least one of the above layers further containing an organoleptic biodegradable additive to accelerate decomposition of the film laminate.

A film of laminate construction for producing on a packaging machine a flexible container for containing food comprising:
a. a layer of natural kraft for forming an outside layer of the container;
b. a layer of adhesive;
c. a metalized layer
d. a layer of PE;
e. a layer of Tie;
f. a layer of EVOH;
g. a layer of Tie;
h. a layer of PE sealant for forming an inside layer of the container;
wherein at least one of the above layers further containing an organoleptic biodegradable additive to accelerate decomposition of the film laminate.

### BRIEF DESCRIPTION OF THE DRAWINGS

The present invention will now be described by example only with reference to the following drawings in which:

FIG. 1 is a schematic representation of the layers of the laminate material, which are laminated together in order to produce the high barrier film laminate showing schematically the various layers and how they are laminated together.

FIG. 2 is a schematic representation of the layers of the laminate material, which are laminated together in order to produce the high barrier film laminate showing schematically the various layers and how they are laminated together.

FIG. 3 is a schematic representation of the layers of the laminate material, which are laminated together in order to produce the high barrier film laminate showing schematically the various layers and how they are laminated together.

FIG. 4 is a schematic representation of the layers of the laminate material, which are laminated together in order to produce the high barrier film laminate showing schematically the various layers and how they are laminated together.

FIG. 5 is a schematic representation of the layers of the laminate material, which are laminated together in order to produce the high barrier film laminate showing schematically the various layers and how they are laminated together.

FIG. 6 is a schematic representation of the layers of the laminate material, which are laminated together in order to produce the high barrier film laminate showing schematically the various layers and how they are laminated together.

FIG. 7 is a schematic representation of the layers of the laminate material, which are laminated together in order to produce the high barrier film laminate showing schematically the various layers and how they are laminated together.

FIG. 8 is a schematic representation of the layers of the laminate material, which are laminated together in order to produce the high barrier film laminate showing schematically the various layers and how they are laminated together.

FIG. 9 is a schematic representation of the layers of the laminate material, which are laminated together in order to produce the high barrier film laminate showing schematically the various layers and how they are laminated together.

FIG. 10 is a schematic representation of the layers of the laminate material, which are laminated together in order to produce the high barrier film laminate showing schematically the various layers and how they are laminated together.

FIG. 11 is a schematic representation of the layers of the laminate material, which are laminated together in order to produce the high barrier film laminate showing schematically the various layers and how they are laminated together.

FIG. 12 is a schematic representation of the layers of the laminate material, which are laminated together in order to produce the high barrier film laminate showing schematically the various layers and how they are laminated together.

FIG. 13 is a schematic representation showing themes of the various materials shown in FIGS. 1 through 12 this figure is a legend for the materials being depicted in FIGS. 1 through 12.

### DESCRIPTION OF THE PREFERRED EMBODIMENTS

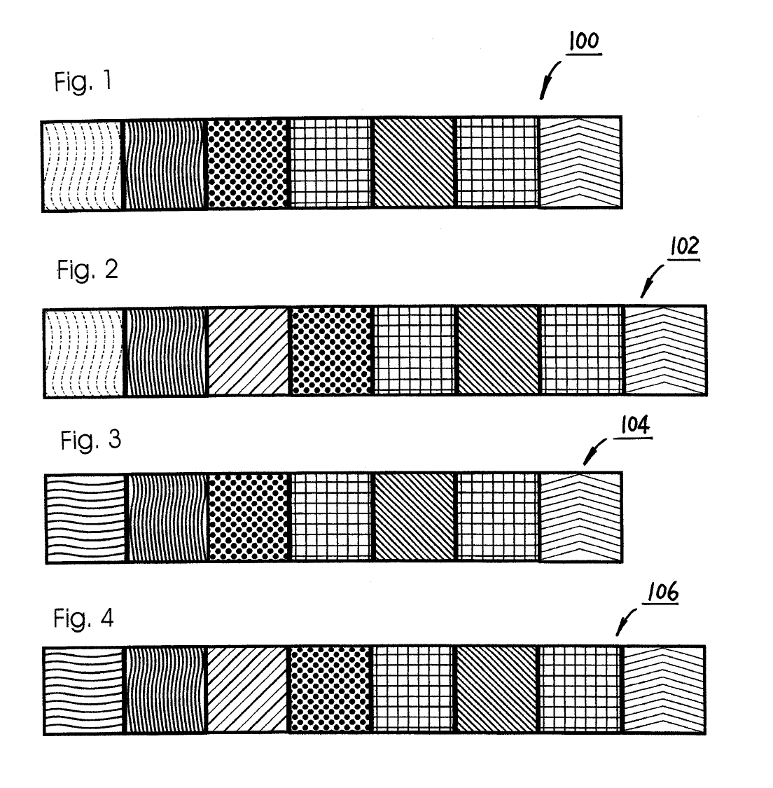

The present concept is depicted in FIGS. 1 through 12 inclusively which are examples of high barrier film laminates made in accordance with the concept depicted and described in this specification.

Examples of barrier film laminate are schematically depicted as 100, 102, 104, 106, 108, 110, 112, 114, 116, 118, 120, 122.

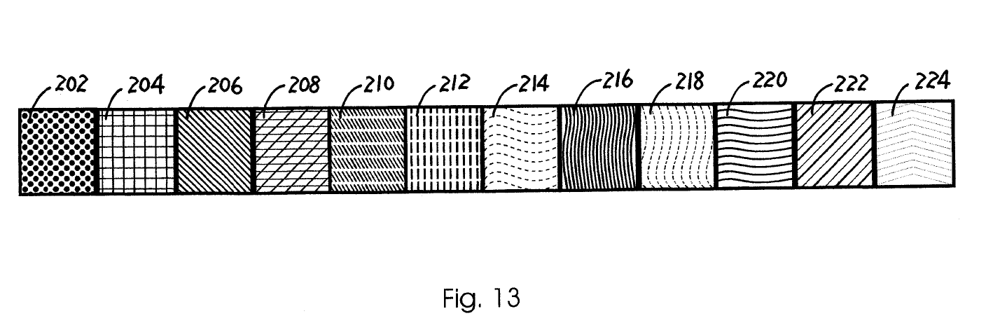

FIG. 13 is a legend depicting the materials that are being used and shown in the laminates in FIGS. 1 through 12.

Referring now to FIG. 13 which depicts in legend style the materials which make up the layers depicted in FIGS. 1 through 12 will now be defined:
202: PE: Polyethylene
204: Tie Layer: Adhesive for bonding two layers together
206: EVOH: Ethylene vinyl alcohol
208: Bio-HDPE: Biodegradable high-density polyethylene
210: PCR-PET: Post consumer recycled polyester
212: Bio-PA: Biodegradable Nylon
214: Bio-PP: Biodegradable Polyethylene
216: Adhesive: Glue used to bond two layers together
218: NATURAL KRAFT: Kraft paper of varying weights and thicknesses
220: WHITE KRAFT: White paper of varying weights and thicknesses.
222: Metalized Layer: Foil like layer
224: PE Sealant: Polyethylene Sealant normally used as an inner most layer of the laminate.

Examples of the laminate construction are shown in FIGS. 1 through 12. The examples depict on the left most side of the page the outer most layer and on the right most side of the page the inner most layer.

FIG. 1 for example shows high barrier film laminate 100 which is comprised of:
Natural Kraft/Adhesive/PE/Tie/EVOH/Tie/PE Sealant.

FIG. 2 is a schematic representation of high barrier film laminate 102 which is comprised of:
Natural Kraft/Adhesive/MetalizedLayer/PE/Tie/EVOH/Tie/PE Sealant

FIG. 3 is a schematic representation of high barrier laminate 104 which is comprised of:
White Kraft/Adhesive/PE/Tie/EVOH/Tie/PE Sealant

FIG. 4 is a schematic representation of high barrier laminate 106 which is comprised of:
White Kraft/Adhesive/Metalized Layer/PE/Tie/EVOH/Tie/PE Sealant

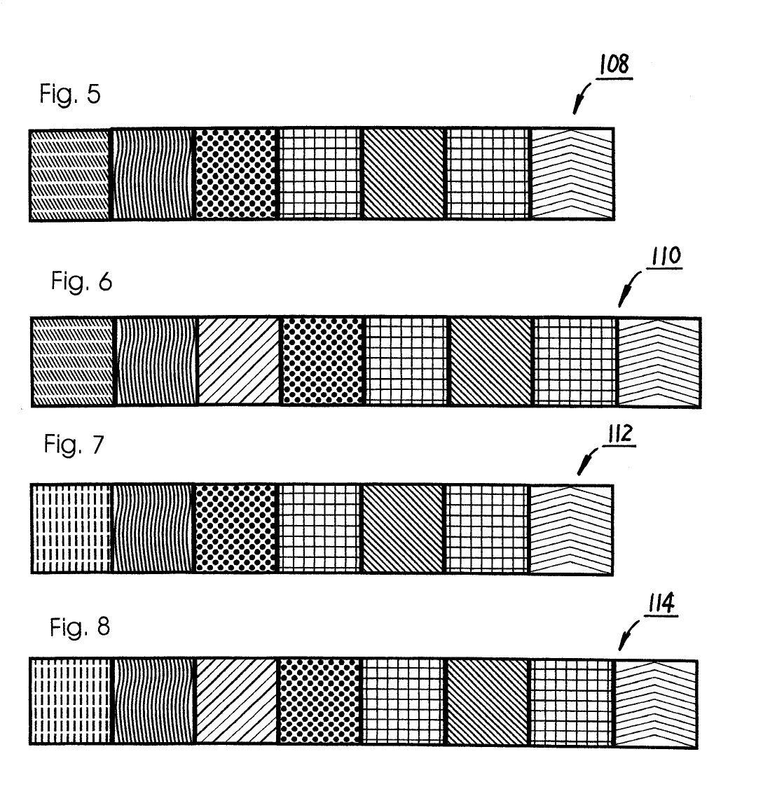

FIG. 5 is a schematic representation of high barrier laminate 108 which is comprised of:
PCR-PET/Adhesive/PE/Tie/EVOH/Tie/PE Sealant

FIG. 6 is a schematic representation of high barrier laminate 110 which is comprised of:
PCR-PET/Adhesive/Metalized Layer/PE/Tie/EVOH/Tie/PE Sealant

FIG. 7 is a schematic representation of high barrier laminate 112 which is comprised of:
Bio-PA/Adhesive/PE/Tie/EVOH/Tie/PE Sealant

FIG. 8 is a schematic representation of high barrier laminate 114 which is comprised of:
Bio-PA/Adhesive/Metalized Layer/PE/Tie/EVOH/Tie/PE Sealant

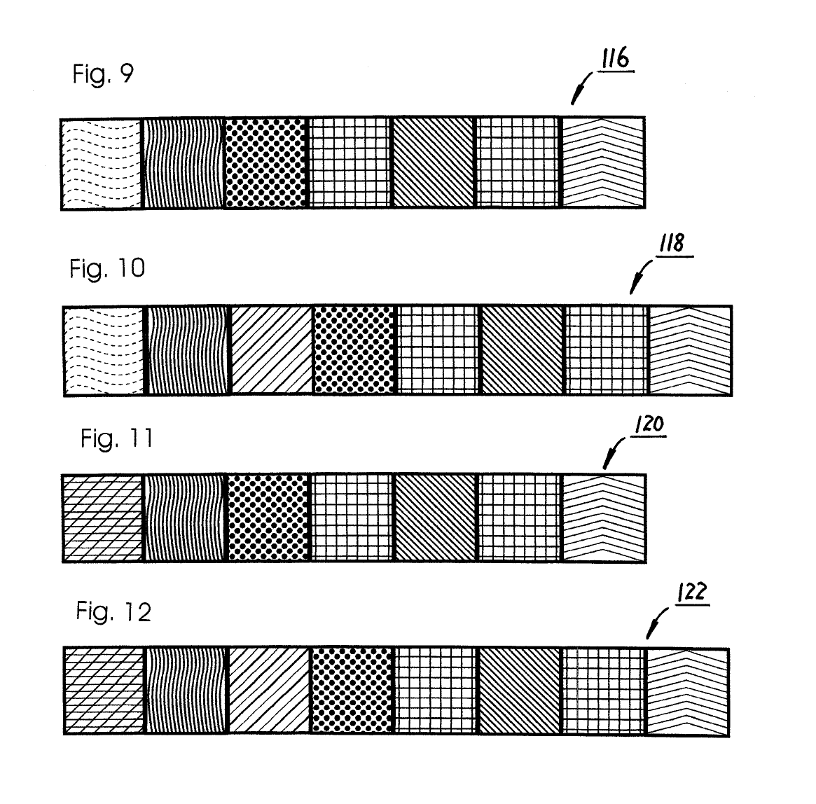

FIG. 9 is a schematic representation of high barrier laminate 116 which is comprised of:
Bio-PP/Adhesive/PE/Tie/EVOH/Tie/PE Sealant

FIG. 10 is a schematic representation of a high barrier laminate 118 which is comprised of:
Bio-PP/Adhesive/Metalized Layer/PE/Tie/EVOH/Tie/PE Sealant

FIG. 11 is a schematic representation of a high barrier laminate 120 which is comprised of:
Bio-HDPE/Adhesive/PE/Tie/EVOH/Tie/PE Sealant

FIG. 12 is a schematic representation of a high barrier laminate 122 which is comprised of:
Bio-HDPE/Adhesive/Metalized Layer/PE/Tie/EVOH/Tie/PE Sealant

High barrier film laminates that are made in accordance with the above described methods can be made into pre-made side gusset bags, square bottom bags, stand up pouches or offered as roll stock for further pouch making and filling operations. In addition one way de-gassing valves and tin ties can also be installed to the high barrier film laminate packages.

All of these high barrier film laminates described above namely high barrier film laminates 100 through and including high barrier film laminate 122 include a biodegradable additive that are made to FDA and SCF standards. The biodegradable additive is normally a blend of organoleptic compounds containing no heavy metals and having no adverse effects on plants or insects. Biodegradable additives biodegrade into water CO₂ and small amounts of organic biomass all of which are beneficial to plant growth.

The benefits of the presently described high barrier film laminates will be known to a person skilled in the art in particular the ability for these packaging materials to biodegrade without any adverse effects on the environment is a significant improvement and benefit over the existing packaging materials.

I claim:

1) A barrier film of laminate construction used in the food packaging industry for producing containers for food packaging, the barrier film of laminate construction comprising:
a) a layer of natural kraft for forming an outside layer of the container;
b) a layer of adhesive;
c) a layer of PE;
d) a layer of Tie;
e) a layer of EVOH;
f) a layer of Tie;
g) a layer of PE sealant for forming an inside layer of the container;
wherein at least one of the above layers further containing an organoleptic biodegradable additive to accelerate decomposition of the film laminate.

2) The film of laminate construction claimed in claim 1 wherein the layer of natural kraft is replaced with a layer of White Kraft.

3) The film of laminate construction claimed in claim 1 wherein the layer of natural kraft is replaced with a layer of PCR-PET.

4) The film of laminate construction claimed in claim 1 wherein the layer of natural kraft is replaced with a layer of BIO-PA.

5) The film of laminate construction claimed in claim 1 wherein the layer of natural kraft is replaced with a layer of BIO-PP.

6) The film of laminate construction claimed in claim 1 wherein the layer of natural kraft is replaced with a layer of BIO-HDPE.

7) A barrier film of laminate construction used in the food packaging industry for producing containers for food packaging, the barrier film of laminate construction comprising:
a) a layer of natural kraft for forming an outside layer of the container;
b) a layer of adhesive;
c) a metalized layer
d) a layer of PE;
e) a layer of Tie;
f) a layer of EVOH;
g) a layer of Tie;
h) a layer of PE sealant for forming an inside layer of the container;
wherein at least one of the above layers further containing an organoleptic biodegradable additive to accelerate decomposition of the film laminate.

8) The film of laminate construction claimed in claim 7 wherein the layer of natural kraft is replaced with a layer of white kraft.

9) The film of laminate construction claimed in claim 7 wherein the layer of natural kraft is replaced with a layer of PCR-PET.

10) The film of laminate construction claimed in claim 7 wherein the layer of natural kraft is replaced with a layer of BIO-PA.

11) The film of laminate construction claimed in claim 7 wherein the layer of natural kraft is replaced with a layer of BIO-PP.

12) The film of laminate construction claimed in claim 7 wherein the layer of natural kraft is replaced with a layer of BIO-HDPE.
